(19) United States
(12) Patent Application Publication
(10) Pub. No.: US 2013/0222396 A1
(43) Pub. Date: Aug. 29, 2013

(54) SYSTEM AND METHOD FOR CREATING AND DISPLAYING AN ANIMATED FLOW OF TEXT AND OTHER MEDIA FROM AN INPUT OF CONVENTIONAL TEXT

(71) Applicants: Anthony Confrey, Concord, MA (US); Dennis Downey, East Falmouth, MA (US)

(72) Inventors: Anthony Confrey, Concord, MA (US); Dennis Downey, East Falmouth, MA (US)

(21) Appl. No.: 13/757,116

(22) Filed: Feb. 1, 2013

Related U.S. Application Data
(63) Continuation of application No. 12/501,215, filed on Jul. 10, 2009, now abandoned.
(60) Provisional application No. 61/134,473, filed on Jul. 10, 2008.

(51) Int. Cl. G06T 13/00

(52) U.S. Cl. CPC G06T 13/00
USPC 345/473

(57) ABSTRACT

A system and method for generating and displaying text on a screen as an animated flow from a digital input of conventional text. The Invention divides text into short-scan lines of coherent semantic value that progressively animate from invisible to visible and back to invisible. Multiple line displays are frequent. The effect is aesthetically engaging, perceptually focusing, and cognitively immersive. The reader watches the text like watching a movie. The Invention may exist in whole or in part as a standalone application on a specific screen device. The Invention includes a manual authoring tool that allows the insertion of non-text media such as sound, image, and advertisements.

### REFERENCE TO PENDING PRIOR PATENT APPLICATION

This patent application claims benefit of pending prior U.S. Provisional Patent Application Ser. No. 61/134,473, filed Jul. 10, 2008 by Anthony Confrey et al. for SYSTEM AND METHOD FOR CREATING AND DISPLAYING AN ANIMATED FLOW OF TEXT AND OTHER MEDIA FROM AN INPUT OF CONVENTIONAL TEXT (Attorney's Docket No.: DOWNEY-1 PROV).

The above-identified patent application is hereby incorporated herein by reference.

### FIELD OF THE INVENTION

The Invention relates to the presentation of text and accompanying media on screen devices such as computers, televisions, digital frames, phones, handhelds, e-readers, and glance media. More specifically, the Invention defines a new mode of reading that is uniquely possible only on an electronic screen.

### BACKGROUND OF THE INVENTION

The structural conventions of traditional text, including paragraphs, stanzas, sentences, and most punctuation, evolved to serve the communication requirements of an earlier, non-electric, static medium: the printed page. Presently, most screen displays of textual content employ these same conventions even as the interfacing medium is natively more dynamic.

Reading a block of text on a screen is more difficult than reading the same text on a page. The visual field is constricted, forcing us to scroll. The resolution of words and letters is diminished, forcing us to squint. The subtle extra effort can be tedious and wearying, and is underscored by the fact that we commonly print out any text that needs to be read with careful understanding. Just as significant, the native advantages of presenting text dynamically on an electric light device are ignored.

Text on a screen does not need to stand still. Composed for a device that turns on, words can slide, pop, fade, and layer in combinations that compel a reader's attention and enhance their understanding and enjoyment.

### SUMMARY OF THE INVENTION

The Invention converts conventional static text into a new form of text that flows as you read. Punctuation and grammar are parsed to provide semantic divisions, alignments, timing and motion. Text is displayed sparsely in short-scan lines that appear and disappear in gentle animation. The motions engage and transfix. The reader watches the text like watching a movie. The significance of the Invention is that every text inherently contains its own animation.

A Text Flow may be augmented with additional media including sound, drawing, image, video, and secondary flowing texts. Advertisements may be presented within the Text Flow. A generated Text Flow may be customized by an author to adjust display positions and timings and to enhance the presentation through the direct insertion of additional media. The authoring of customized Text Flows constitutes a new writing form and a new means of creative expression.

In one form of the invention, there is provided a method for displaying text on a screen, comprising:

displaying the text as an animated flow generated from a digital input of conventional text.

And in one preferred form of the invention, the text is displayed by a software application, within a screen device as a sequence of Clusters of short-scan Line Segments, with the Line Segments in each Cluster progressively animating from invisible to visible until the complete Cluster of Line Segments is displayed simultaneously on the screen and remains displayed for a sufficient duration for all the Line Segments to be read by a reader before the entire Cluster fades back to invisible, either in unison or in a progression, thereafter to be proceeded by the next Cluster in the sequence until all Clusters comprising the text have been displayed.

And in one preferred form of the invention, the method comprises:

(a) dividing the text into single-scan or short-scan Line Segments of at least one word; and

(b) grouping said Line Segments into semantically-related Animation Clusters of at least one Line Segment, wherein
(i) each Line Segment when displayed, progressively animates from invisible to visible to display at a discreet location on the screen; and
(ii) each successive Line Segment in the Cluster, when displayed, progressively animates from invisible to visible after the previous Line Segment has become visible or is nearly visible; and
(iii) each successive Line Segment, when displayed, displays at a set distance below the preceding Line Segment, creating a cascade effect and display; until
(iv) all Line Segments in the cluster are displayed together, and remain displayed together for a specific readable duration relative to the number of Line Segments in the cluster, and the total number of words in the Animation Cluster; until
(v) the entire cluster of Line Segments progressively animates from visible to invisible, either in unison or in a progression;

(c) grouping said Animation Clusters into Cluster Groups of at least one Animation Cluster, that are the semantic equivalent of a Verse or Paragraph in conventional text, wherein
(i) the first Animation Cluster in a Cluster Group, when displayed, begins after a defined delay from the completion of the preceding Cluster Group; and
(ii) each successive Animation Cluster in a Cluster Group, when displayed, progressively animates as described above after the preceding Animation Cluster in the Cluster Group; and
(iii) the beginning of a successive Animation Cluster may or may not overlap with the ending of its precedent Animation Cluster; and
(iv) the beginning of a successive Animation Cluster may or may not be delayed relative the ending of its precedent Animation Cluster; and
(v) when the last Animation Cluster in a Cluster Group animates back to invisibility the Cluster Group is complete and the next Cluster Group begins;

(d) animating the total number of generated Cluster Groups in progressive succession to create a flowed display of the original text.

And in one preferred form of the invention, the generation of divisions and groupings is achieved automatically through the application of an algorithmic tool comprising:

(a) a Parser that is a software application that implements Regular Expressions; and

(b) said Parser includes a Lexicon and algorithms that determine Parts-of-Speech, whereby

(c) the Parser assigns a Part-of-Speech to each word in the text; and

(d) the Parser analyzes the text by Part-of-Speech to determine grammar and semantics; and

(e) the Parser applies Rule Sets to divide the text by punctuation and grammar creating Lines, Clusters and Cluster Groups, while assigning position, timing, and animation effects to each; and

(f) the Parser generates a description of the text as a flow animation that can be interpreted and displayed by a flow player application on a screen device.

And in one preferred form of the invention, the generation of divisions and groupings is achieved through a combination of an automatic generation tool and the application of an authoring tool comprising:

(a) the automatic creation of a Flow description as recited in claim 4; and

(b) the review of the automatic result in a Flow Composer application by an author; and

(c) the modification of the flow text by the author using the editing capabilities of the Composer application.

And in one preferred form of the invention, the method allows an author using a Flow Composer tool to insert non-textual media such as sound, image, and drawing into a generated Text Flow.

And in one preferred form of the invention, the divisions and groupings are generated by the direct input of text into a manual authoring tool.

And in one preferred form of the invention, the method allows for dual reading modes on the same text display screen, wherein an animated flow display of a text is synced with a contrasting conventional static display of the same text on the same screen device, comprising:

(a) enhancing the software file that displays the conventional text on the device with word sequence markers; and

(b) including word sequence markers within each Animation Cluster in the flow version of the text as defined in the software file that specifies the flow; and

(c) programming a toggle on the screen device that syncs the displays according to the word sequence, wherein
(i) the toggle is a button on the device or screen, or
(ii) the toggle is a change in screen orientation.

And in one preferred form of the invention, the generation and display of an animated flow of a conventional text is used for the purpose of teaching a student how to read the conventional text.

And in one preferred form of the invention, the text processing comprises an extension to regular expression matching and syntax whereby matches may be made on words matching particular parts of speech.

And in one preferred form of the invention, the method further comprises the addition to standard regular expression syntax of a meta-sequence of the form: ‘POS:_xyz_’, where xyz is replaced by a standard annotation for specific parts of speech (N=noun, VB=verb etc), and will match a word being that part of speech within the context of the matched expression.

And in form of the invention, there is provided apparatus for displaying text on a screen, comprising:

apparatus for displaying the text as an animated flow generated from a digital input of conventional text.

And in one preferred form of the invention, the text is displayed by a software application within a screen device as a sequence of Clusters of short-scan Line Segments, with the Line Segments in each Cluster progressively animating from invisible to visible until the complete Cluster of Line Segments is displayed simultaneously on the screen and remains displayed for a sufficient duration for all the Line Segments to be read by a reader before the entire Cluster fades back to invisible, either in unison or in a progression, thereafter to be proceeded by the next Cluster in the sequence until all Clusters comprising the text have been displayed.

And in one preferred form of the invention, the apparatus comprises:

(a) apparatus for dividing the text into single-scan or short scan Line Segments of at least one word; and

(b) apparatus for grouping said Line Segments into semantically-related Animation Clusters of at least one Line Segment, wherein
(i) each Line Segment, when displayed, progressively animates from invisible to visible to display at a discreet location on the screen; and
(ii) each successive Line Segment in the Cluster, when displayed, progressively animates from invisible to visible after the previous Line Segment has become visible or is nearly visible; and
(iii) each successive Line Segment, when displayed, displays at a set distance below the preceding Line Segment, creating a cascade effect and display; until
(iv) all Line Segments in the cluster are displayed together, and remain displayed together for a specific readable duration relative to the number of Line Segments in the cluster, and the total number of words in the Animation Cluster; until
(v) the entire cluster of Line Segments progressively animates from visible to invisible, either in unison or in a progression;

(c) apparatus for grouping said Animation Clusters into Cluster Groups of at least one Animation Cluster, that are the semantic equivalent of a Verse or Paragraph in conventional text, wherein
(i) the first Animation Cluster in a Cluster Group, when displayed, begins after a defined delay from the completion of the preceding Cluster Group; and
(ii) each successive Animation Cluster in a Cluster Group, when displayed, progressively animates as described above after the preceding Animation Cluster in the Cluster Group; and
(iii) the beginning of a successive Animation Cluster may or may not overlap with the ending of its precedent Animation Cluster; and
(iv) the beginning of a successive Animation Cluster may or may not be delayed relative the ending of its precedent Animation Cluster; and
(v) when the last Animation Cluster in a Cluster Group animates back to invisibility the Cluster Group is complete and the next Cluster Group begins;

(d) apparatus for animating the total number of generated Cluster Groups in progressive succession to create a flowed display of the original text.

And in one preferred form of the invention, the generation of divisions and groupings is achieved automatically through the application of an algorithmic tool comprising:

(a) a Parser that is a software application that implements Regular Expressions; and

(b) said Parser includes as Lexicon and algorithms that determine Parts-of-Speech, whereby

(c) the Parser assigns a Part-of-Speech to each word in the text; and

(d) the Parser analyzes the text by Part-of-Speech to determine grammar and semantics; and

(e) the Parser applies Rule Sets to divide the text by punctuation and grammar creating Lines, Clusters and Cluster Groups, while assigning position, timing, and animation effects to each; and
(f) the Parser generates a description of the text as a flow animation that can be interpreted and displayed by a flow player application on a screen device.

And in one preferred form of the invention, the generation of divisions and groupings is achieved through a combination of an automatic generation tool and the application of an authoring tool comprising:

(a) the automatic creation of a Flow description as recited in claim 4; and

(b) the review of the automatic result in a Flow Composer application by an author; and

(c) the modification of the flow text by the author using the editing capabilities of the Composer application.

And in one preferred form of the invention, the apparatus allows an author using a Flow Composer tool to insert non-textual media such as sound, image, and drawing into a generated Text Flow.

And in one preferred form of the invention, the divisions and groupings are generated by the direct input of text into a manual authoring tool.

And in one preferred form of the invention, the apparatus allows for dual reading modes on the same text display screen, wherein an animated flow display of a text is synced with a contrasting conventional static display of the same text on the same screen device, comprising:

(a) enhancing the software file that displays the conventional text on the device with word sequence markers; and

(b) including word sequence markers within each Animation Cluster in the flow version of the text as defined in the software file that specifies the flow, and

(c) programming a toggle on the screen device that syncs the displays according to the word sequence, wherein
(i) the toggle is a button on the device or screen, or
(ii) the toggle is a change in screen orientation.

And in one preferred form of the invention, the generation and display of an animated flow of a conventional text is used for the purpose of teaching a student how to read the conventional text.

And in one preferred form of the invention, the text processing comprises an extension to regular expression matching and syntax whereby matches may be made on words matching particular parts of speech.

And in one preferred form of the invention, the apparatus further comprises the addition to standard regular expression syntax of a meta-sequence of the form; ‘POS:_xyz_’, where xyz replaced by a standard annotation for specific puts of speech N=noun, VB=verb etc), and will match a word being that part of speech within the context of the matched expression.

### BRIEF DESCRIPTION OF THE DRAWINGS

FIG. 1 is a high-level flow-chart of the system elements of the Invention.

FIG. 2 is a block diagram showing the major elements of the Parser.

FIG. 3 is a logic flow diagram of the process of the Parser.

FIG. 4 shows an example of a Regular Expression Rule execution.

FIG. 5 is a block diagram of the elements of the Lexicon in relation to the Word Profiler.

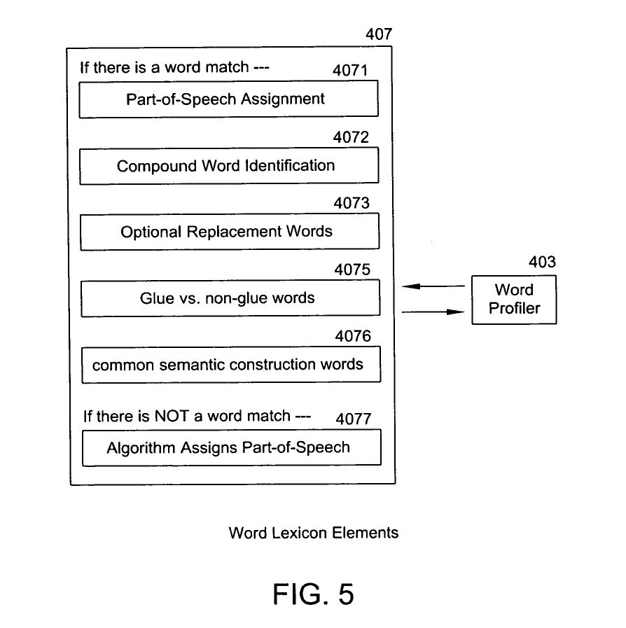

FIG. 6 is a non-relational block diagram showing the major elements of the Player.

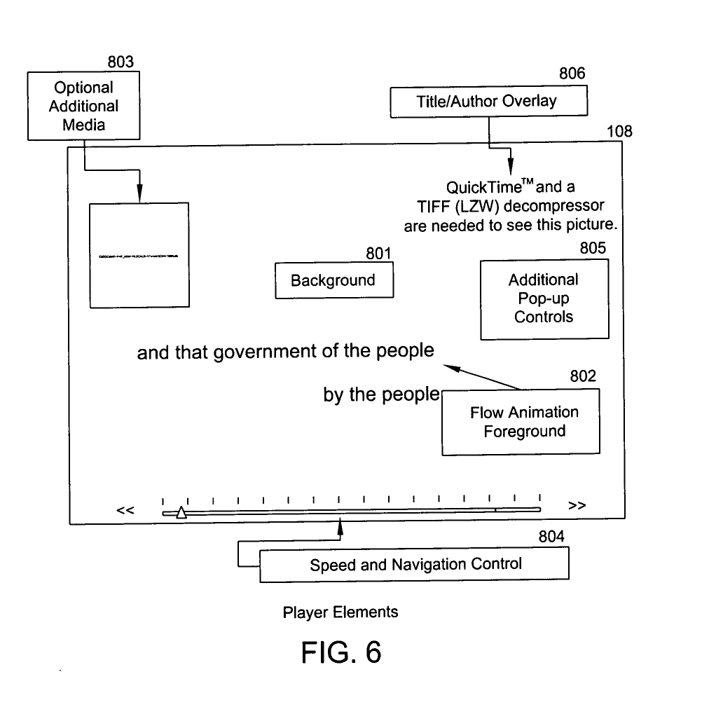

FIG. 7 is a relational diagram of the display elements in a Flow.

FIG. 8 is a relational diagram of the display elements in a Compound Word.

FIG. 9 is a relational diagram of the display elements in a Line with LineParts.

FIG. 10 is a relational diagram at the display elements in a Cluster of Lines.

FIG. 11 provides a Glossary of the Part-of-Speech (POS) Identifiers.

FIG. 12 demonstrates Sample Rule Sets for Line Divisions Based on Punctuation.

FIG. 13 demonstrates Sample Rule Sets that Refine certain Part-of-Speech Indentifiers.

FIG. 14 demonstrates Sample Rule Sets for Line Divisions Based on Grammar.

FIG. 15 shows a Single Line Cluster, with Line Parts and Accordion Animation.

FIG. 16 shows Multi-Line Cluster, with Line Parts and Accordion Animation.

FIG. 17 shows a Word Replacement Animation.

FIG. 18 provides an Example of XML Structured Description.

FIG. 19 provides a Screen Shot of a Composer Tool for Authoring Flows.

FIG. 20 demonstrates Dual Reading Modes on a Handheld Screen.

### DETAILED DESCRIPTION OF THE PREFERRED EMBODIMENTS

### Elements

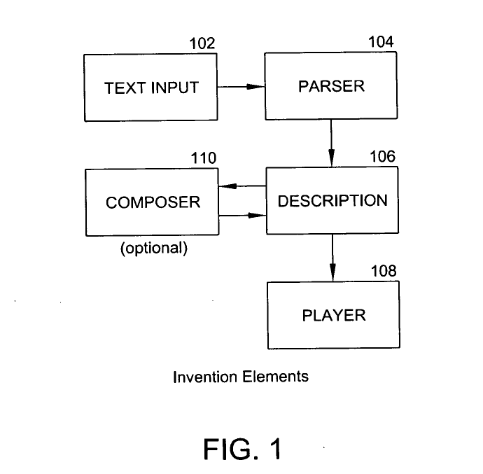

FIG. 1 shows a high-level flow-chart of the system elements of the Invention. From a digital input of conventional text [102], an algorithmic Parser analyzes, divides, and transforms the text to generate a Structured Description [106] of the text as an animated flow. An optional Composer Tool [110] allows an author or publisher to view the flow defined by the Structured Description [106] and to modify the result, including the insertion of additional media. The Structured Description [106] is transmitted to a Player [108] on a consumer screen device. The Player [108] interprets the Structured Description [106] and displays the text as a flow in a sequence of short-scan animations.

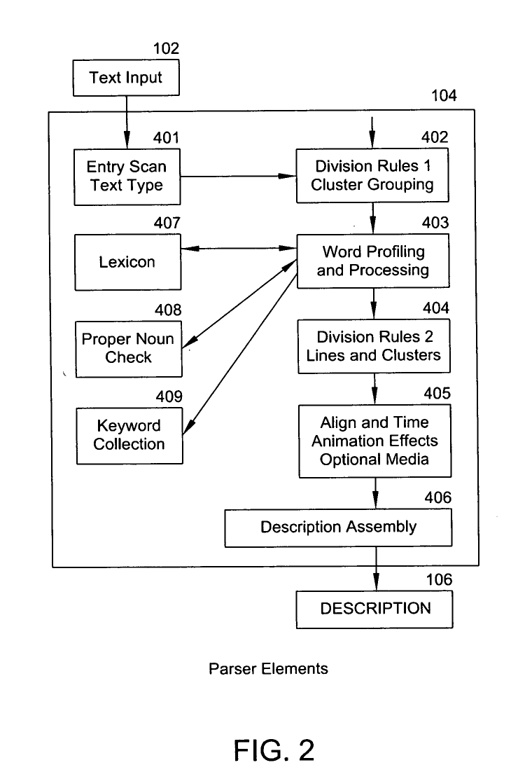

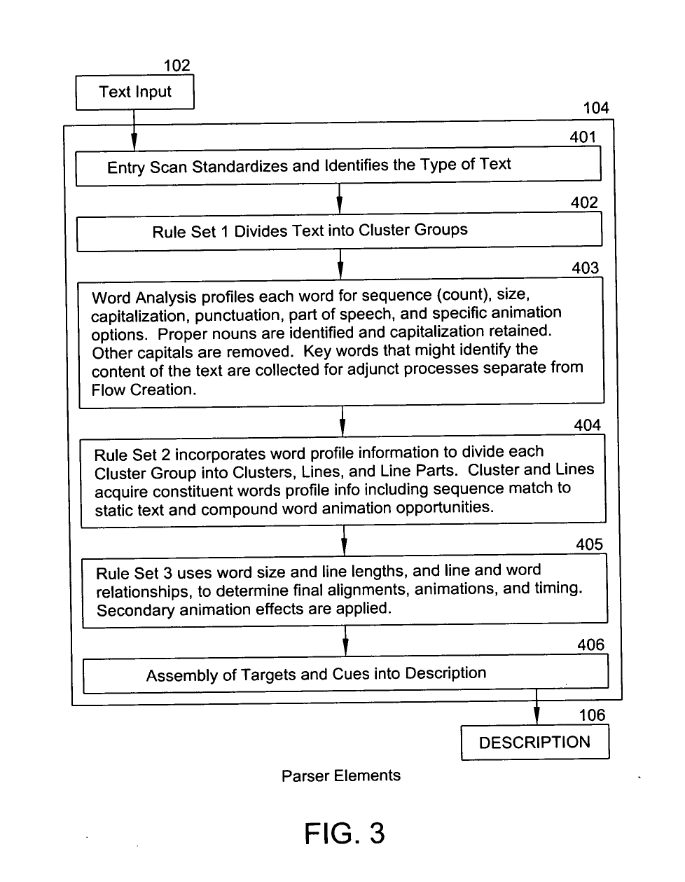

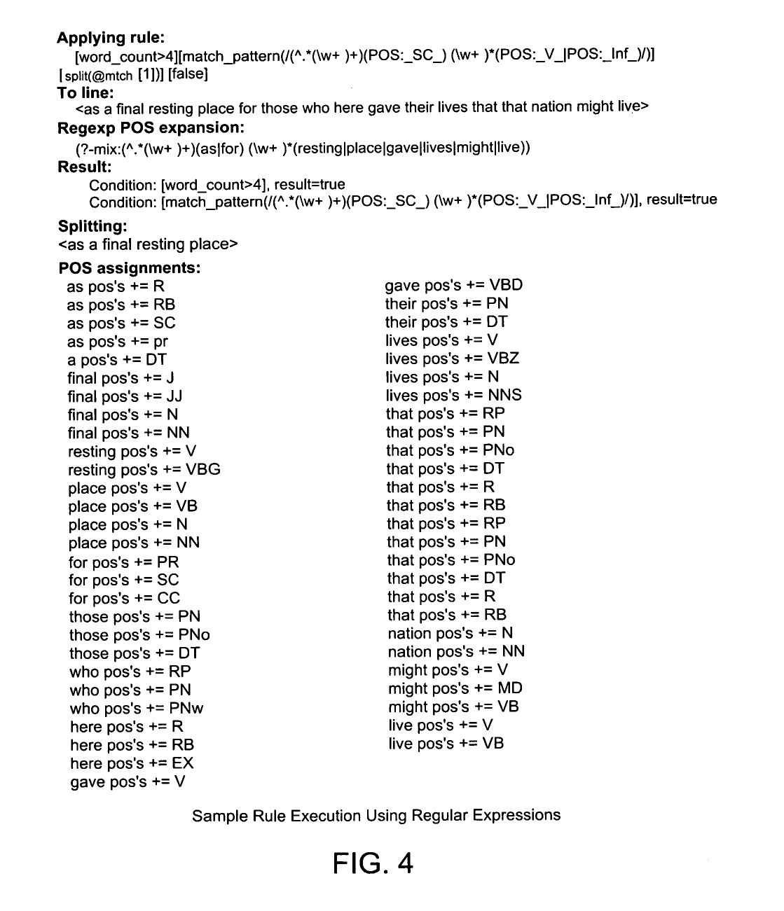

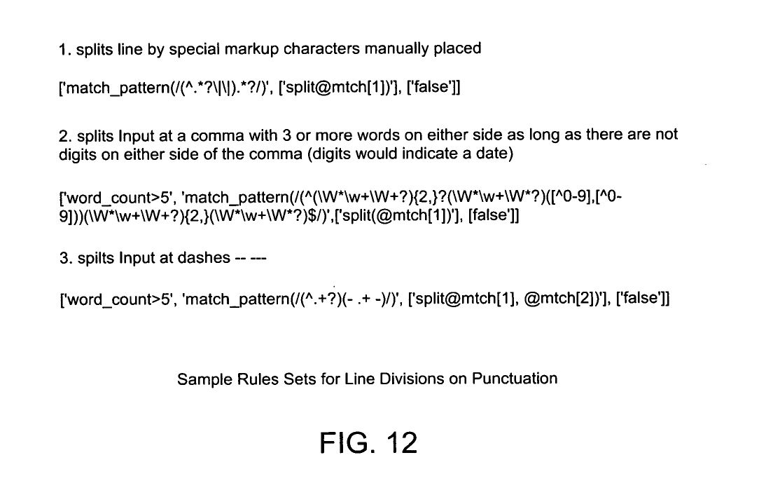

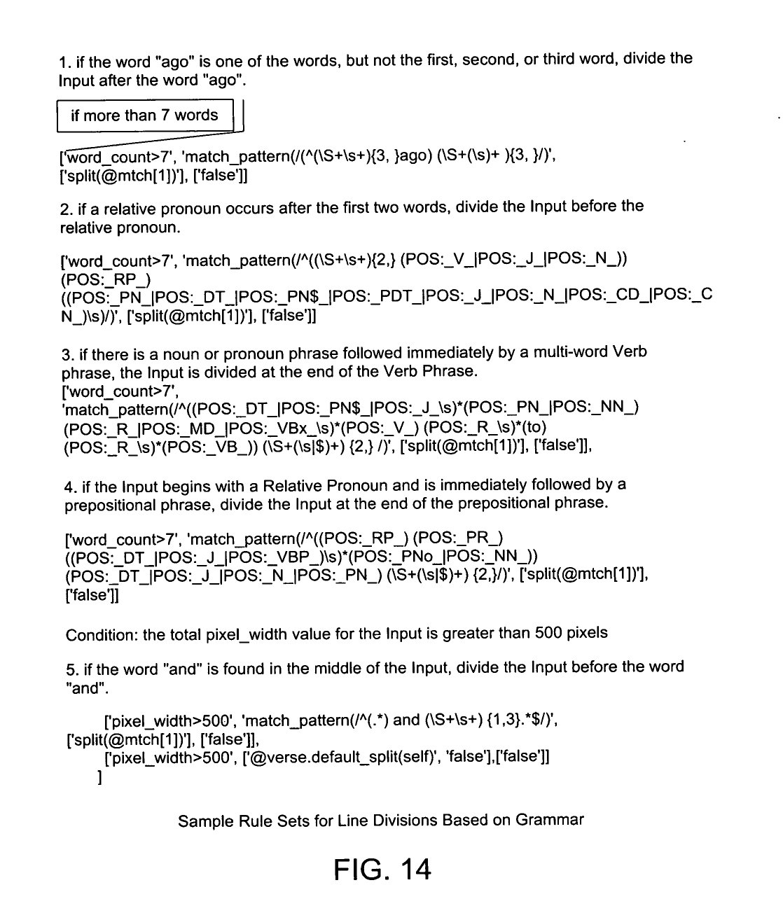

The Parser [104] is a software application composed in any software language that implements Regular Expressions. The Parser accepts an input of digital text [102] in an encoded format such as ASCII or UTF-8, and applies rules to convert the text into the Structured Description [106] of an animated Text Flow [802]. In computing, Regular Expressions define a formal language that provides a concise and flexible means for identifying strings of text of interest, such as particular characters, words, or patterns of characters. Among other mechanisms, Parser Rules [402,404] use Regular Expressions, extended with a Part-of-Speech capability [FIG. 4], to match structural and grammatical conventions in the text [FIGS. 12 and 14]. The Parser [FIGS. 2 and 3] divides the text into a series of sequential display targets, assigning position, motion, and timing cues.

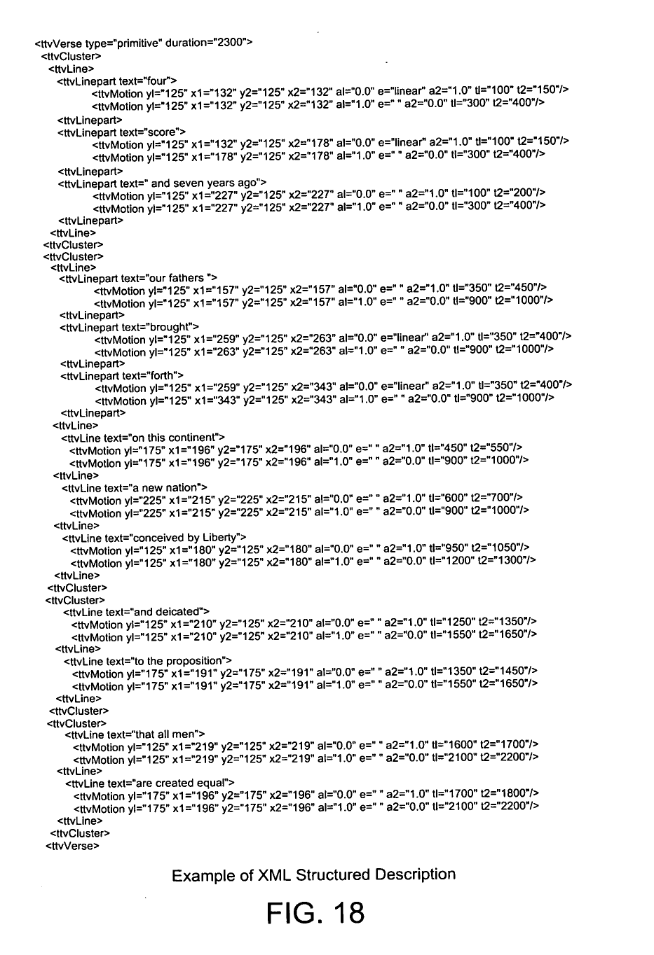

The Structured Description [106] of a Text Flow [802] models all elements of the animation and can be transmitted from a server to a Player [108] running on a display device. A preferred embodiment of a Structured Description [106] composed XML [FIG. 18].

Within the Structured Description, text is presented as a sequence of Cluster Groups [821] separated by a duration of white space (i.e. no foreground display). Cluster Groups in a Text Flow derive directly from the organizational conventions of the specific Input Text: for prose, a Cluster Group equates to a paragraph; for poetry, to a stanza, for a play or screenplay, to a character's dialogue, etc.

Within a Cluster Group [821], text is displayed as a sequence of Clusters. Most typically, a Cluster [822] is the timed, simultaneous display of multiple Lines at different vertical positions on the screen. A Cluster may include a single Line. Clusters often equate to a sentence, clause, or list in the Input Text.

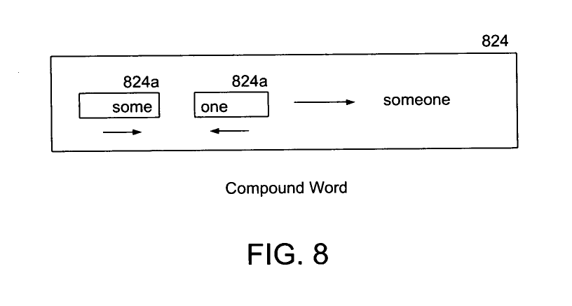

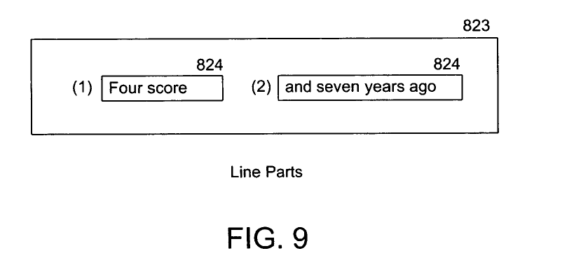

Within a Cluster, a Line [823] is defined as a word or group of words that display simultaneously in a single horizontal position in the Player. A Line [823] may be further divided into LineParts [824], each of which may start display at a different time or in motion from a different start point. LineParts visually aggregate to form a single Line display [FIG. 9]. The animation of individual Words and Compound Words [824a] within a Line are implemented with LineParts [FIG. 8].

The Player [108] can be any software application that interprets the Structured Description [106] [FIG. 18] of a Flow [821] to render it as animation on a screen display device. The Player may be implemented as an application inside of a web browser application or as a feature of a web browser application. The Player may also exist as an application that is specific to the operating system of the screen display device. The essential requirements of the Player are the ability to accept and interpret the Structured Description [FIG. 18] and to provide an animation on the screen device based on the Structured Description.

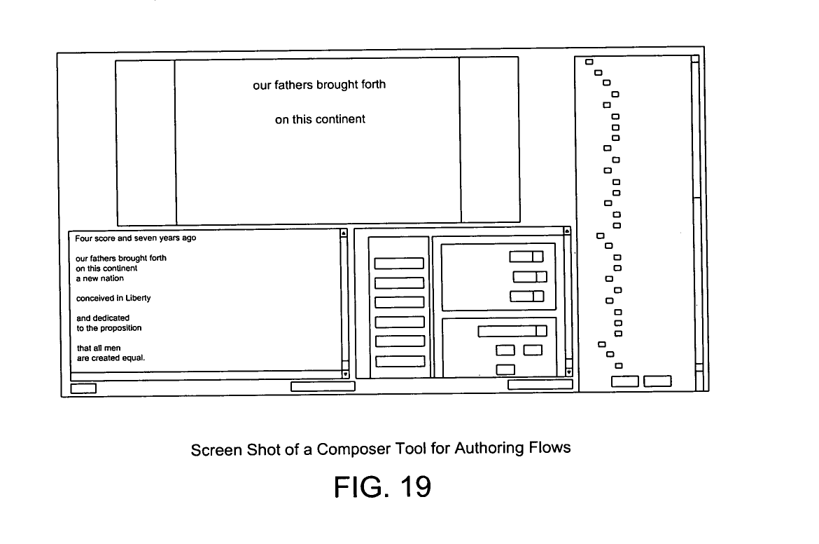

In a preferred embodiment, the Player includes User Controls [804] that allow the reader to pause, play, or rewind the Flow and to customize the presentation for speed, size, and navigation of the Flow content. In a further embodiment, Additional Controls [805] provide for the traversal of web links embedded in the Flow and access to other Flows that may reside on a server or within the displaying device. One embodiment of the Player allows the automatic conversion of the Player window into the optional Composer Tool [110] [FIG. 19].

User Controls may exist as a graphical interface on the same surface as the Flow, or they can be embedded within the displaying device. In a preferred embodiment for a handheld screen, the User Controls are mapped to the screen orientation and other hand manipulation cues.

In a preferred embodiment, the Composer Tool [110] is an optional, software application and graphical interface [FIG. 19] that allows an author or publisher to preview and customize a previously generated Text Flow. Additionally, the Composer Tool can be used to initiate an original Text Flow through the direct input of typed or pasted text. Within the Composer Tool, alterations can be made to the text itself, as well as to other aspects of the Text Flow including line divisions, clustering, cluster groups, positioning, alignments, timings, fades, and animations [FIG. 19]. The Composer tool also allows the visual, aural, or semantic enhancement of a Text Flow through the insertion of Other Media [803] such as sound, music, drawings, and images.

In a preferred embodiment, an auxiliary mode of the Composer allows an author or publisher to provide the Parser with preference hints that modify how the Parser generates display targets. A second auxiliary mode allows an author or publisher to override the Parser and directly generate or modify the Structured Description [FIG. 18].

### What is A Text Flow?

Where conventional text presents as an homogeneous, static block that must be visually traversed, a Text Flow is a gentle river of words and thought that engages the reader directly. In a Text Flow, sentences and paragraphs are dissolved, creating an intense focus on words, phrases, and meanings. Syntax is preserved and renewed by the semantic division of the text, relational displays and alignments, timings, speed, and motion.

### Sparse, Uncluttered, And Calm

A Text flow displays the text sparsely: just a few words a time. The screen is largely empty. In the preferred embodiment, the background white and the text is black. Simultaneously displayed, multiple lines are vertically spaced generously from each other creating a sense of breath and space. In the preferred embodiment, a TextFlow displays no more than 4 vertical lines in a single display. The spaciousness of the display allows the words of the text to be seen and read with ease and calm.

### Mesmerization

The near-constant, gentle motions of a TextFlow display transfix the reader's attention.

### Punctuation By Alignment, Timing, And Background

Punctuation, as separation of thought, is achieved in the Invention through the sequential display of targets and the alternation of display with no-display (background only). Within the invention, punctuation is a matter of time length (display duration) and timing (display occurrence). Transitions of display Lines up from and back into the Background provide a form of semantic punctuation that is unique to the invention.

### Conventional Punctuation Is Removed

Most conventional text punctuation is removed in the Invention. The Parser [104] strips periods, colons, semi-colons and most commas in preparing text content for display. In the preferred embodiment, question marks and exclamations are separated slightly from the previous word and animate into view after a 0.5 second delay. Contractions are retained and often are animated. With the exception of proper nouns [408], the Parser strips capitalization as it occurs to mark the beginning of a sentence.

### Invisible Grid

Display Lines are presented at set vertical positions on the screen device. The resulting aesthetic is of an invisible grid. Words and Lines appear (and disappear) at set verticals on the screen. When a word or Line moves to its final display place, it often appears to do so magnetically as if it belongs to the place and pops to it. A magnetic effect is achieved through the combination of set display destinations (the grid) with the application of easing equations in the motion animation.

### Method Of Generation

Essentially, the Invention takes text apart and puts it back together as an animation. How the text is taken apart and redisplayed depends on the nature of the original text as well as on the screen size and display requirements of the display device.

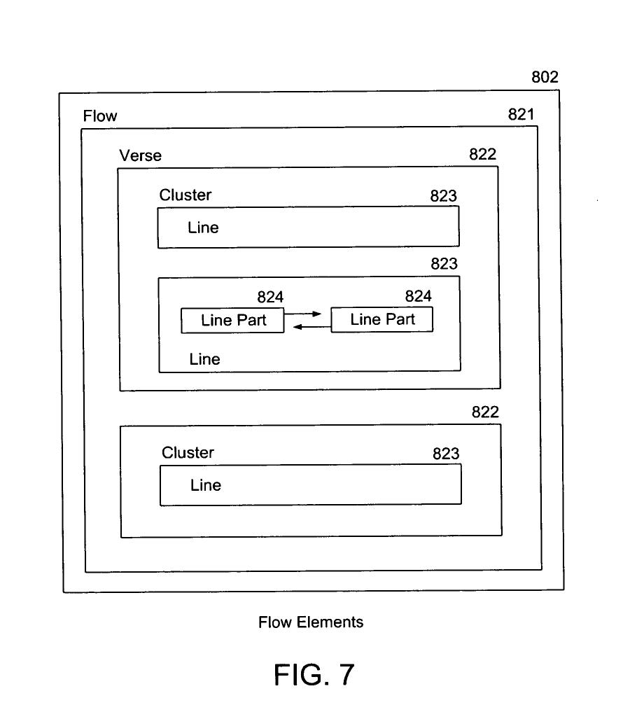

Each instance of the Invention begins with the input of digital text into the Parser application. The Parser divides text into Cluster Groups, Clusters, Lines, and LineParts [FIG. 7].

The Invention optimizes the division of the text into display units so as to retain and enhance the meaning of the text. As much as possible, noun phrases, verb phrases, prepositional phrases, relative clauses, and other semantic units (including dates, proper names, numbers, foreign expressions, and parenthetical thoughts) are identified and kept intact within a single line display.

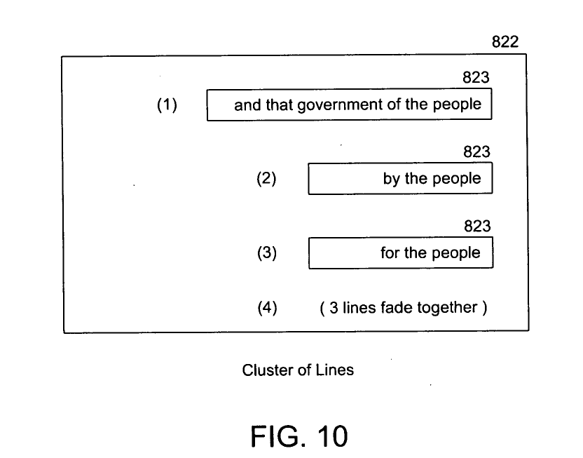

Larger clauses are recognized and grouped as Clusters of simultaneous, multiple-line displays at different vertical positions on the screen [FIG. 10]. Common rhetorical structures such as the repetition or slight variation of a word within a clause or sentence are detected by the invention and can result in alignments or animations that emphasize the intended effect [see Lincoln's rhetoric in FIG. 10]. In general, the relative alignment of sequential and/or simultaneous display units is a desired effect of the invention both for aesthetic purposes and for enhancing readability.

The following section gives an overview of the Rule Engine and then describes in detail each step in the Parser's overall processing flow [FIG. 3]. Note that this mechanism does not preclude other methods of defining the Structured Description from a text. For example, manual annotation of the text, such as can be performed in the Composer, or simple line and word length divisions, could also be used.

### Rule Engine

The flow creation logic of the Parser is significantly embodied in the Rule Engine. Rules are grouped into rule sets. Rule sets are dedicated to a particular activity such as dividing lines, determining the part-of-speech for words, etc. Specific rule sets may be optionally invoked on a text depending on its origin and structure, but all rules in a rule set are applied.

A rule is composed of two main parts: a set of conditions to be matched and a set of actions to perform if the conditions are matched. The conditions are composed of a set of primitive functions returning true or false based on the text, and a set of regular expressions describing patterns to be matched in the text. The conditions include, but are not limited to:
Word count in a line
Pixel width of a line if presented on a screen
Position of as line in a Cluster Group or cluster
The sentence number of which a line is part.

When all conditions for a rule are matched its actions are applied. These actions may have the effect of splitting a Line into two or three pieces, reducing the potential parts-of-speech for a word, applying an animation etc. The final action in the set returns a true or false value. A true value indicates that the rules actions may have changed the systems overall state such that earlier rules in the rule set may now apply. In this case processing is restarted for the whole rule set. Rule processing continues until all applicable rules have been applied.

### Regular Expressions Extended for Part-of-Speech

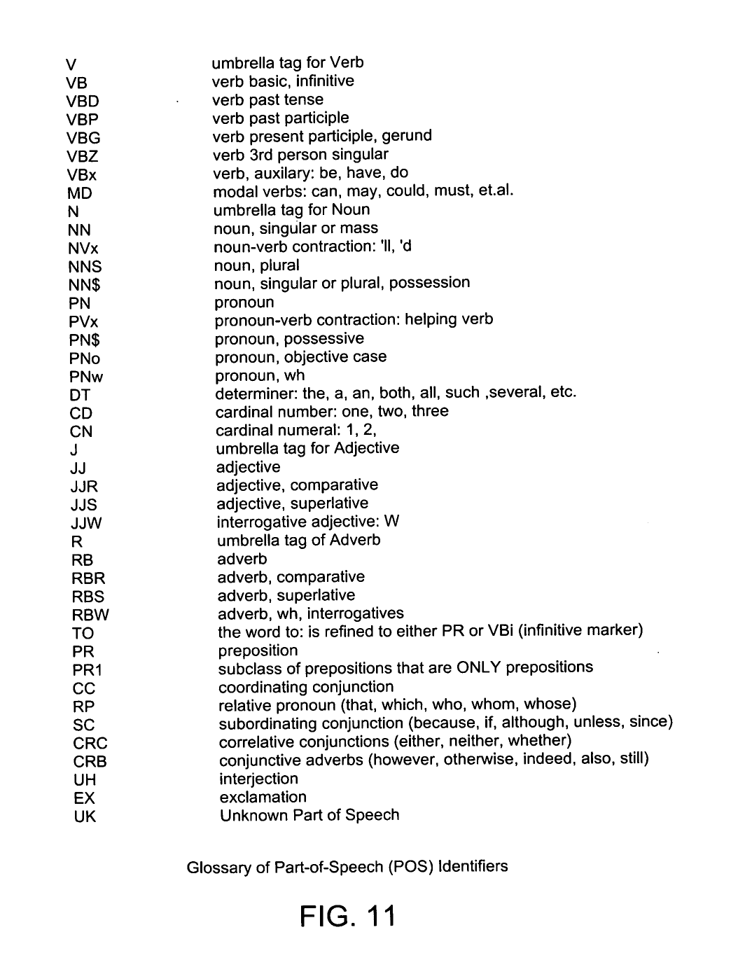

The standard regular expression model is extended to allow parts of speech to be matched. The parts of speech as listed in FIG. 11 can be indicated in a regular expression by using a POS:_pos_{—} syntax, where pos is the required part of speech. Thus for example within a regular expression “(POS:_N_|POS:_VB_)” will match a word that, in the context of the current phrase, is a noun or a verb.

### POS Pre-Processing

This regular expression extension is implemented by means of pre-processing the regular expression in the context of the text string it is to match. Using previously computed or referenced POS identifications for each word, the POS:_xyz_syntax is replaced by the specific text of the potential word matches.

For example, in matching the expression:

/(̂.*(\w+)+)(POS:_SC_)(\w+)*(POS:_V_|POS:_Inf_)/

against the phrase
‘as a final resting place for those who here gave their lives that that nation might live’
the expression could be pre-processed into the following:

/(̂.*(\w+)+)(as|for)(\w+)*(gave|might|live)/

where ‘as’ and ‘for’ are the subordinating conjunctions in the phrase, and ‘gave’, ‘might’ and ‘live’ are the verbs, [see also. FIG. 4]

### Text Normalization

As the input text [102] may come from different sources, it is first normalized into a single well-known character set [401]. Performing this step reduces the number of cases that need to be considered in rules. For example there are many ways that a ‘-’ (dash) character may be encoded on web pages. By translating to a single version on input we do not need to consider the others.

### Cluster Group Boundary Detection

The text is also scanned to identify high-level structure [401]. Examples of source and structure include poetry, prose, dialogue script, or a news-oriented web page. Division based on double carriage returns is performed to turn grouped sentences, such as paragraphs or poetic verse, into Cluster Groups [402].

### Sentence Detection

Divisions based on sentence dividers such as periods, question and exclamation marks, are performed to create an initial set of Lines [402].

### Word Profiling

Each word in the text is stripped of appended punctuation [403] and passed through a Lexicon [407] to identify the word for Part-of-Speech [4071], compound nature [4072], potential replacement words for the word [4073], determination of the word as a glue or non-glue word in the language [4075], and the setting of a flag for certain words to check for common semantic constructions [4076]. If the word is not found in the Lexicon, the word is input through a special algorithm [4077] that assigns a Part-of-Speech to the word based on the word endings and/or context of the word in the text. Note that the Lexicon can, and commonly does, identify multiple potential Parts-of-Speech for a given word.

### Disambiguation Of Multiple Parts-of-Speech

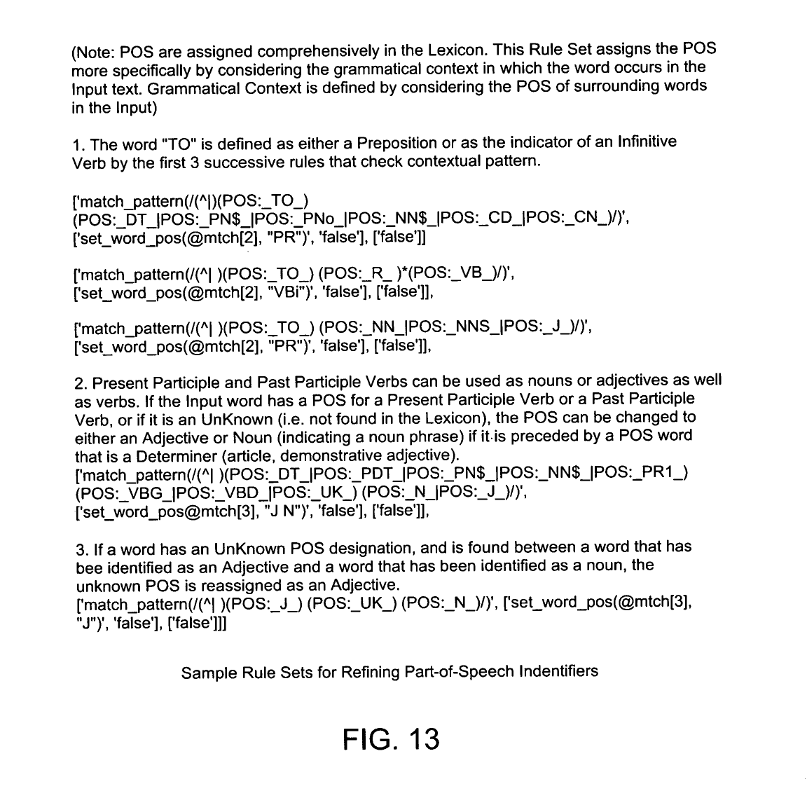

Many words have multiple parts of speech depending on context. A Rule Set [404] is applied to examine the structure of each Lines text and to reduce the set of potential parts-of-speech for words that are important for line division. FIG. 13 demonstrates one potential rule set for disambiguating, multiple parts-of-speech assignments.

### Word Sequence Retained

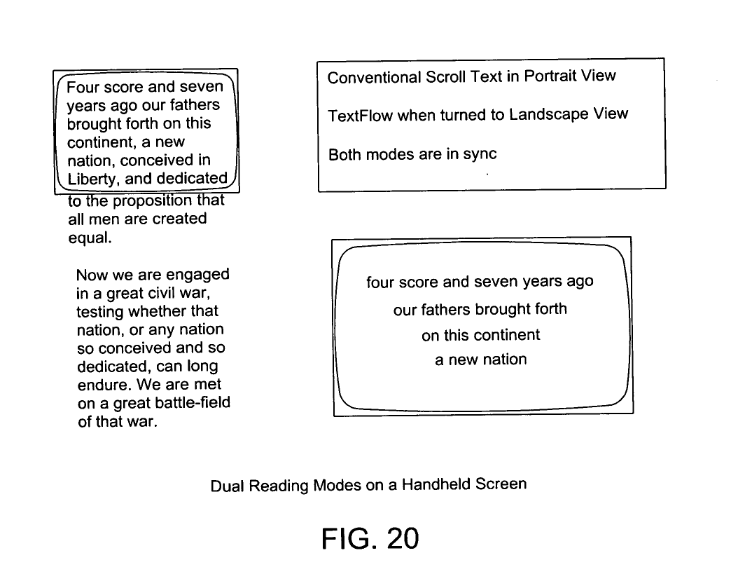

When the words profiled for parts-of-speech [403], a count is kept so that the each word has an originating number that maps to its sequence position in the original text. In the preferred embodiment, as Lines and Clusters are formed, each Cluster assumes an identifying range of sequence numbers derived from the words within the cluster. This sequence range can be used to synch the TextFlow display with a conventional display of the same text on the same reading screen. [see FIG. 20]

### Initial Structural Division Of Lines

Each Line is split based on punctuation. Semi-colons, colons, commas, dashes, and ellipses, are used to separate phrases in a Line. These phrases are then split off into separate Lines [404].

### Separation Of Parentheticals

In the preferred embodiment, sets of two or more words contained within matching pairs of brackets, braces, parentheses, or dashes are separated on their own Line, and the bracketing pair animate into place as if enclosing the text. Parenthetical content that exceeds 6 or more words is assigned its own Cluster.

### Division Into Display Lines

When the words of the text have been individually profiled and parts-of-speech determined, another Rule Set [404] is applied to divide the text into a sequence of displayable Lines and LineParts. Rules combine part-of-speech analysis with punctuation, word length, and line length, as well as relationships between the text in adjacent lines, to determine the best division of the text into display line targets. FIG. 12 displays a rule set for Line divisions based on punctuation.

### Cluster Identification

Based on the division of the text of a Cluster Group into displayable Lines, an algorithm is then applied to determine the display Clusters [404]. If all lines composing a single textual sentence or phrase can be fit on a screen simultaneously then they form a single Cluster, otherwise multiple Clusters are created based on a combination of dividing the lines evenly across Clusters and keeping tightly related lines within the same Cluster.

### Horizontal Cluster Layout

Within a Cluster the Lines are laid out centrally on the screen. There are a known number of potential display line positions. The middle Line of the Cluster will be centered on the vertical with the previous and subsequent Lines above and below it respectively. In the preferred embodiment, the maximum number of display line positions is 4, and the most commonly used are 2 or 3.

### Share And Anchor Identification

Within a Cluster adjacent lines are examined for commonalities of text or theme. Shared words, prefixes, suffixes, and common vowels may be used to vertically align, or ‘Anchor’, sequential lines in a Clustered display or in a sequential replacement of Lines on the same horizontal. In some cases, shared words and alignments are emphasized by a ‘Share’ animation. An example would be the dropping of a shared word or letter between two lines that are horizontally aligned on the content.

### Horizontal Layout

Horizontal layout of lines is performed using their Shares/Anchors if any, and based on alignment heuristics if not. Alignment heuristics seek to left, right or center align adjacent lines for aesthetic effect and readability. In the preferred embodiment, all Lines in a Cluster are centered horizontally on the screen, except when otherwise specifically aligned.

### Line Transition Effects

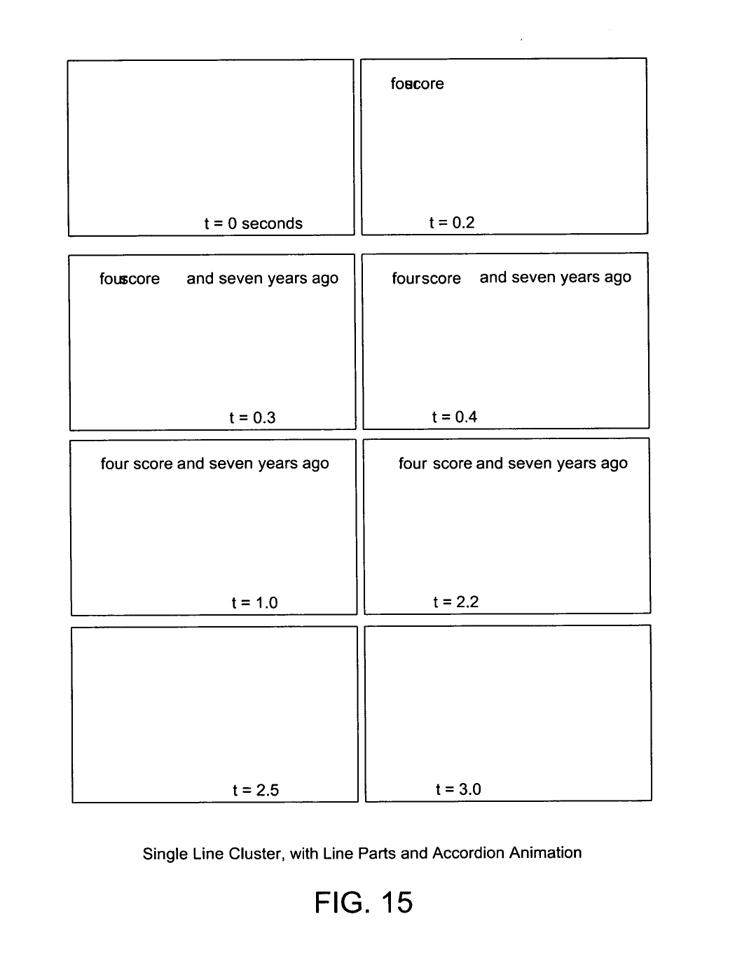

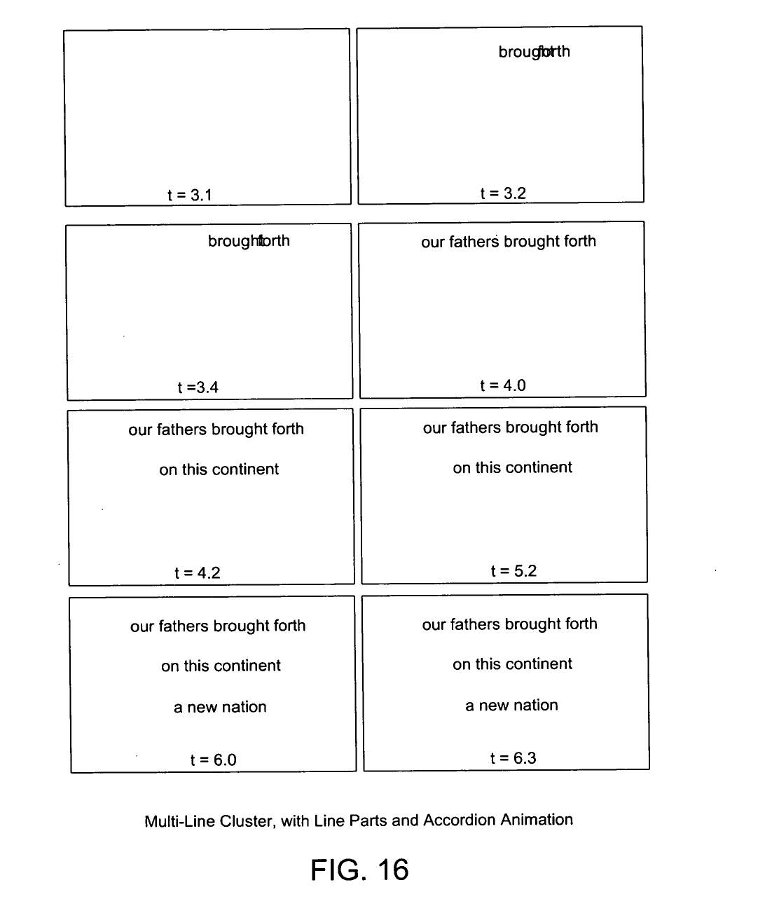

In addition to Share and Anchor effects, the text in a single Line may also exhibit transition effects. These are animations that move or fade text into position on initial Line display or as the Line fades off the screen. Line effects are created where the texts punctuation or grammar indicates separation of thought, or where there is aesthetic value [FIGS. 15-17].

### Timing

Based an Clustering, placements, word number and length, and animation effects the line and effect timing is defined [405]. This determines the fade in and fade out times for static lines and the motion timing for animations.

Based on the internal model generated by the steps above the structured description is then created as an XML annotated document. This description be output and manually adjusted prior to subsequent processing.

A translation is next performed which turns the Structured Description [106] unto a set of primitive text labels each of which has a set of motions in three dimensions over time, the third dimension being the opacity, or alpha [FIG. 18]. This set of labels embodies the complete description of the Flow and is passed to the Player for presentation.

### Identifying Common Syntactical Constructions

Certain words in a language are commonly used in combinations with other specific words to create common syntactical constructions. (Example: Either . . . or . . . ) The Lexicon flags certain words so as to trigger a search for possible pair words in the same line of text [4076]. Common syntactical constructions are important for semantic alignments and often provide an animation opportunity within the Flow display.

### Some Words Have Ready Replacements

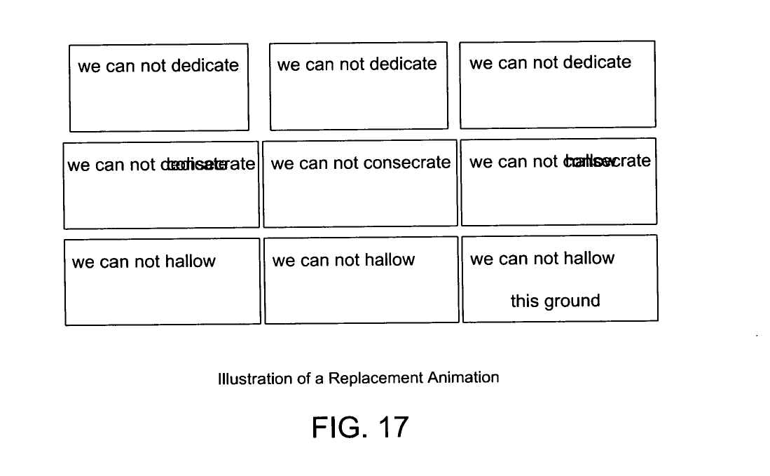

Replacement words [4073] are assigned within the Lexicon to a small percentage of words that have common synonyms or homonyms. Replacement words represent an animation opportunity within a Flow and may be used to create a sequenced alternation of a word with its replacements within a display Line. FIG. 17 demonstrates a Replacement Word animation.

### Compound Words May Animate

A compound word [4072] is a word made of two or more smaller words. Compound words represent an animation opportunity and may be displayed within a Flow through an application of LineParts within a display Line [FIG. 8].

### Additional Media

The invention provides for the inclusion of non-textual media [803] into the flow of the reading display, including sound, image, video, and vector drawings.

Non-textual media may pre-exist in a library within an application of the invention, or it may be transferred into the application from external files on server or on the consumer's screen device.

### Advertisements

An advertisement, including links, may be inserted into a Flow in textual or non-textual format. The advertisement may be in the form of a Flow, or it may append to a Flow as non-textual media. Advertisements may be matched to the content of Flow using algorithms relating to the word content in the Flow [409]. Advertisements from third party ad serving platforms may be accessed and included in a Flow.

In a unique and idiosyncratic aspect to the Invention, the existence and location of the letter ‘o’ in a word in a display Line of text constitute an animation opportunity for the Flow display. O's can also be used for inserting vector drawings of eyes and eyebrows, especially in instances of double o's in a word (example “look”).

### Identifying The Content Of A Text

In addition to displaying text as a Flow, the Invention includes functionality to profile the content of a text and the interests of the reader by the words of the text. The Lexicon identifies words as glue-or-non-glue [4075]. Glue words are the most commonly used words in a language. Glue words pull a language together to create phrases and sentences and appear in almost every expression of thought. Examples of glue words include articles, prepositions, and helping verbs. In contrast, non-glue words present unique meanings: nouns, adjectives, and verbs. The significance of non-glue words for the Invention is that they provide a means of profiling the content of the input text. In combination with Proper Nouns [408], the Word Profiler [403] in the Parser collects non-glue words in a Key Word Collection [409] that can be used to tag (categorize) the text for search and save purposes, as well as to target the interest of the reader for advertising and/or to suggest related content.

### Modifications

It will be understood that many changes in the details, materials, steps and arrangements of parts, which have been herein described and illustrated in order to explain the nature of the invention, may be made by those skilled in the art without departing from the principles and scope of the present invention.

What is claimed is:

1. A method for displaying text on a screen, comprising:
displaying the text as an animated flow generated from a digital input of conventional text.

2. A method according to claim 1 wherein the text is displayed by a software application within a screen device as a sequence of Clusters of short-scan Line Segments, with the Line Segments in each Cluster progressively animating from invisible to visible until the complete Cluster of Line Segments is displayed simultaneously on the screen and remains displayed for a sufficient duration for all the Line Segments to be read by a reader before the entire Cluster fades back to invisible, either in unison or in a progression, thereafter to be proceeded by the next Cluster in the sequence until all Clusters comprising the text have been displayed.

3. A method according to claim 1 comprising:
(a) dividing the text into single-scan or short-scan Line Segments of at least one word; and
(b) grouping said Line Segments into semantically-related Animation Clusters of at least one Line Segment, wherein
(i) each Line Segment, when displayed, progressively animates from invisible to visible to display at a discreet location on the screen; and
(ii) each successive Line Segment in the Cluster, when displayed, progressively animates from invisible to visible after the previous Line Segment has become visible or is nearly visible; and
(iii) each successive Line Segment, when displayed, displays at a set distance below the preceding Line Segment, creating a cascade elect and display; until
(iv) all Line Segments in the cluster are displayed together, and remain displayed together for a specific readable duration relative to the number of Line Segments in the cluster, and the total number of words in the Animation Cluster; until
(v) the entire cluster of Line Segments progressively animates from visible to invisible, either in unison or in a progression,
(c) grouping said Animation Clusters into Cluster Groups of at least one Animation Cluster, that are the semantic equivalent of as Verse or Paragraph in conventional text, wherein
(i) the first Animation Cluster in a Cluster Group, when displayed, begins after a defined delay from the completion of the preceding Cluster Group; and
(ii) each successive Animation Cluster in a Cluster Group, when displayed, progressively animates as described above after the preceding Animation Cluster in the Cluster Group; and
(iii) the beginning of a successive Animation Cluster may or may not overlap with the ending of its precedent Animation cluster; and
(iv) the beginning of a successive Animation Cluster may or may not be delayed relative the ending of its precedent Animation Cluster; and
(v) when the last Animation Cluster in a Cluster Group animates back to invisibility the Cluster Group is complete and the next Cluster Group begins;
(d) animating the total number of generated Cluster Groups in progressive succession to create a flowed display of the original text.

4. A method according to claim 3 wherein the generation of divisions and groupings is achieved automatically through the application of an algorithmic tool comprising:
(a) a Parser that is a software application that implements Regular Expressions; and
(b) said Parser includes a Lexicon and algorithms that determine Parts-of-Speech, whereby
(c) the Parser assigns a Part-of-Speech to each word in the text; and
(d) the Parser analyzes the text by Part-of-Speech to determine grammar and semantics; and
(e) the Parser applies Rule Sets to divide the text by punctuation and grammar creating Lines, Clusters and Cluster Groups, while assigning position, timing, and animation effects to each; and
(f) the Parser generates a description of the text as a flow animation that can be interpreted and displayed by a flow player application on a screen device.

5. A method according to claim 4 wherein the generation of divisions and groupings is achieved through a combination of an automatic generation tool and the application of an authoring tool comprising:
(a) the automatic creation of a Flow description as recited in claim 4; and
(b) the review of the automatic result in a Flow Composer application by an author; and
(c) the modification of the flow text by the author using the editing capabilities of the Composer application.

6. A method according to claim 5 that allows an author using a Flow Composer tool to insert non-textual media such as sound, image, and drawing into a generated Text Flow.

7. A method according to claim 3 wherein the divisions and groupings are generated by the direct input of text into a manual authoring tool.

8. A method according to claim 3 that allows for dual reading modes on the same text display screen, wherein an animated flow display of a text is synced with a contrasting conventional static display of the same text on the same screen device, comprising:
(a) enhancing the software file that displays the conventional text on the device with word sequence markers; and
(b) including word sequence markers within each Animation Cluster in the flow version of the text as defined in the software file that specifies the flow; and
(c) programming a toggle on the screen device that syncs the displays according to the word sequence, wherein
(i) the toggle is a button on the device or screen, or
(ii) the toggle is a change in screen orientation.

9. A method according to claim 1 wherein the generation and display of an animated flow of a conventional text is used for the purpose of teaching a student how to read the conventional text.

10. A method according to claim 1 wherein text processing comprises an extension to regular expression matching and syntax whereby matches may be made on words matching particular parts of speech.

11. A method according to claim 10 further comprising the addition to standard regular expression syntax of a meta-sequence of the form; ‘POS:_xyz_’, where xyz is replaced by a standard annotation for specific parts of speech (N=noun, VB=verb etc), and will match a word being that part of speech within the context of the matched expression.

12. Apparatus for displaying text on a screen, comprising:
apparatus for displaying the text as an animated flow generated from a digital input of conventional text.

13. Apparatus according to claim 12 wherein the text is displayed by a software application within a screen device as a sequence of Clusters of short-scan Line Segments, with the Line Segments in each Cluster progressively animating from invisible to visible until the complete Cluster of Line Segments is displayed simultaneously on the screen and remains displayed for a sufficient duration for all the Line Segments to be read by a reader before the entire Cluster fades back to invisible, either in unison or in a progression, thereafter to be proceeded by the next Cluster in the sequence until all Clusters comprising the text have been displayed.

14. Apparatus according to claim 12 comprising:
(a) apparatus for dividing the text into single-scan or short-scan Line Segments of at least one word; and
(b) apparatus for grouping said Line Segments into semantically-related Animation Clusters of at least one Line Segment, wherein
(i) each Line Segment, when displayed, progressively animates from invisible to visible to display at a discreet location on the screen; and
(ii) each successive Line Segment in the Cluster, when displayed, progressively animates from invisible to visible after the previous Line Segment has become visible or is nearly visible; and
(iii) each successive Line Segment, when displayed, displays at a set distance below the preceding Line Segment, creating a cascade effect and display; until
(iv) all Line Segments in the cluster are displayed together, and remain displayed together for a specific readable duration relative to the number of Line Segments in the cluster, and the total number of words in the Animation Cluster; until
(v) the entire cluster of Line Segments progressively animates from visible to invisible, either in unison or in a progression;
(c) apparatus for grouping said Animation Clusters into Cluster Groups of at least one Animation Cluster, that are the semantic equivalent of a Verse or Paragraph in conventional text, wherein
(i) the first Animation Cluster in a Cluster Group, when displayed, begins after a defined delay from the completion of the preceding Cluster Group; and
(ii) each successive Animation Cluster in a Cluster Group, when displayed, progressively animates as described above after the preceding Animation Cluster in the Cluster Group; and
(iii) the beginning of a successive Animation Cluster may or may not overlap with the ending of its precedent Animation Cluster; and
(iv) the beginning of a successive Animation Cluster may or may not be delayed relative the ending of its precedent Animation Cluster; and
(v) when the last Animation Cluster in a Cluster Group animates back to invisibility the Cluster Group is complete and the next Cluster Group begins;
(d) apparatus for animating the total number of generated Cluster Groups in progressive succession to create a flowed display of the original text.

15. Apparatus according to claim 14 wherein the generation of divisions and groupings is achieved automatically through the application of an algorithmic tool comprising:
(a) a Parser that is a software application that implements Regular Expressions; and
(b) said Parser includes a Lexicon and algorithms that determine Parts-of-Speech, whereby
(c) the Parser assigns a Part-of-Speech to each word in the text; and
(d) the Parser analyzes the text by Part-of-Speech to determine grammar and semantics; and
(e) the Parser applies Rule Sets to divide the text by punctuation and grammar creating Lines, Clusters and Cluster Groups, while assigning position, timing, and animation effects to each; and
(f) the Parser generates as description of the text as a flow animation that can be interpreted and displayed by a flow player application on a screen device.

16. Apparatus according to claim 15 wherein the generation of divisions and groupings is achieved through a combination of an automatic generation tool and the application of an authoring tool comprising:
(a) the automatic creation of a Flow description as recited in claim 4; and
(b) the review of the automatic result in a Flow Composer application by an author; and
(c) the modification of the flow text by the author using the editing capabilities of the Composer application.

17. Apparatus according to claim 16 that allows an author using a Flow Composer tool to insert non-textual media such as sound, image, and drawing into a generated Text Flow.

18. Apparatus according to claim 14 wherein the divisions and groupings are generated by the direct input of text into a manual authoring tool.

19. Apparatus according to claim 14 that allows for dual reading modes on the same text display screen, wherein an animated flow display of a text is synced with a contrasting conventional static display of the same text on the same screen device, comprising:
(a) enhancing the software file that displays the conventional text on the device with word sequence markers; and
(b) including word sequence markers within each Animation Cluster in the flow version of the text as defined in the software file that specifies the flow; and
(c) programming a toggle on the screen device that syncs the displays according to the word sequence, wherein
(i) the toggle is a button on the device or screen, or
(ii) the toggle is a change in screen orientation.

20. Apparatus according to claim 12 wherein the generation and display of an animated flow of a conventional text is used for the purpose of teaching a student how to read the conventional text.

21. Apparatus according to claim 12 wherein text processing comprises an extension to regular expression matching and syntax whereby matches may be made on words matching particular parts of speech.

22. Apparatus according to claim 21 further comprising the addition to standard regular expression syntax of a meta-sequence of the form ‘POS:_xyz_’, where xyz is replaced by a standard annotation for specific parts of speech (N=noun, VB=verb etc), and will match a word being that part of speech within the context of the matched expression.
